(19) United States
(12) Patent Application Publication
(10) Pub. No.: US 2003/0005333 A1
(43) Pub. Date: Jan. 2, 2003

(54) System and method for access control

(76) Inventors: Tetsuya Noguchi, Yamato-shi (JP); Susumu Shimotono, Hadano-shi (JP)

Correspondence Address: IBM CORPORATION, INTELLECTUAL PROPERTY LAW DEPT., P.O. BOX 218, YORKTOWN HEIGHTS, NY, 10598, US

(21) Appl. No.: 10/179,767

(22) Filed: Jun. 24, 2002

(30) Foreign Application Priority Data
Jun. 26, 2001 (JP) 192893

(51) Int. Cl. H04L 9/00

(52) U.S. Cl. 713/201; 713/150

(57) ABSTRACT

A mechanism for access control based on remote procedure calls is established whereby server management costs for the processing associated with the authentication of client access rights and the provision of requested resources can be reduced by distributing these costs among clients. A first client, which has an access right to a server via a network, can issue a remote procedure call to the server. The first client can also communicate with a second client, which doesn't have an access right to the server. The first client requests the server to issue a token, which is a data set for permitting the second client a limited access to the server, and subsequently the token prepared by the server is transmitted to the second client. The second client originally has no access rights relative to the server. However, if the second client transmits a remote procedure call using the received token, limited access is granted. The server performs a process designated by the remote procedure call from the second client. The token includes operating information for designating an operation to be performed based on the remote procedure call, and identification information for identifying the second client.

### BACKGROUND OF THE INVENTION

1. Field of the Invention

The present invention generally relates to an access control technique in a network environment, and in particular to an access control system that is suited to a network environment wherein an unspecified large number of clients access a certain server.

2. Description of the Related Art

As a network environment has been well prepared, multiple computers connected to a network can place remote procedure calls. As a method for providing a secured remote procedure call, there are a RPC (Remote Procedure Call) authentication method, used in a distributed environment system of UNIX, and an SSH (Secure Shell) method, used to securely execute r-type commands, such as rlogin (remote login) and rsh (remote shell). In these methods, a common key is shared using a public key, and through an authentication phase, an encrypted communication path is finally established. Thereafter, the execution of available programs or procedures is controlled by access rights granted to clients by a server. And when, as a result of the execution of a program or procedure, an attempt is made to access a resource requiring a higher access right, permission to call up this resource is also restricted.

Restrictions imposed on access rights are implemented by a server which controls management data for restricting an access to resources, including programs and procedures, for each client or each group to which the client belongs. In this system, generally, clients are registered in advance with the server (including registrations performed for anonymous accesses), and the server has client access right management data, which are used to manage the access rights granted to individual clients, and resource access control management data, which are used to manage the resources the server controls by categorizing them based on classification in the client access right management data.

According to the conventional resource access control method, however, if there is an unexpectedly large increase in the number of clients to exceed the estimated service load, costs associated with the management of the accumulated data are increased. For example, when a server to be connected through ad hoc radio communication is moved, a huge, unspecified number of clients tend to be connected to the server. Further, a WWW (World Wide Web: hereinafter simply referred to as web) server provided for the Internet also tends to be connected to an enormous, unspecified number of clients. In addition, in this types of network system, it is usually unpredictable if clients who have accessed a server only once will later access the server again. Thus, the server may indefinitely retain account management data, and corresponding access control management data for permitted resource access, for clients who may not again assess the server. Therefore, when a server to which a huge, unspecified number of clients can connect is to communicate a specific remote procedure call to each client, the efficiency of the means established to control the above described management data is drastically reduced.

Since it is assumed that many clients will be connected to a web server, control for accessing the resources of the server can be provided for each of the clients by using “cookie” data. However, since originally cookies are employed with the expectation that user anonymity will be maintained and that client identity will not be revealed, it is not general practice for current web servers to base the verification of the security information included in cookies on client authentication, and therefore, server resource access is controlled by using verified cookie information.

A conventional cookie employment method whereby server management costs for resource access control are distributed is disclosed in Japanese Unexamined Patent Publication No. Hei 10-257048 and No. 2000-76192. The se publications describes the technique for using cookie data to record that the clients have been authenticated. That is, a client who has been authenticated can log in to another server by re-using a cookie containing authentication information, so that the client need not log in many times.

A conventional technique for reducing the connection management costs for a server that can be connected to an unspecified number of clients is disclosed in, for example, Japanese Unexamined Patent Publication No. 2000-286840. In this publication, a technique to avoid overconcentration of management of clients at a server is described whereby a client is authenticated by using a public key.

In the reference “Cross-Domain One-Shot Authorization Using Smart Cards”, Richard Au, et al., ACM CCS′ 00, Athens, Greece, a technique is disclosed whereby a token (authorization token), including approval rights for information access management, is transmitted to a client, who later can use the token to access a server to obtain information. According to this technique, the management costs involved in the approval and the distribution of information access rights are reduced by transferring the responsibility for the approval and the distribution of access rights from application servers to an authentication and approval server, which thereafter assumes responsibility for the total management of the clients who access the application servers. As a result, a bottleneck is eliminated to some extent at those servers that previously engaged in the management of information access approval rights.

As is described above, with a current client/server system, when the client seeks to access a resource available at and managed by the server, the server, to prevent an unauthorized access, generally performs a client authentication process and examines available data to ascertain the presence/absence of access rights and the range thereof, and provides the requested service only when the client has submitted an appropriate resource access request. For the server to which an unspecified number of clients can be connected and which has the responsibility of access control, a heavy load is imposed and management costs increase.

In order to provide the access control available with this type of network system, the network system manages 1) an authentication process for controlling the access rights granted to the clients (authentication management), and 2) an access approval process for determining whether the clients can access the resources controlled by the server based on their access rights (access management). And thus, to increase the efficiency of the access control process and to reduce the costs incurred by servers for the two types of management processes, it is preferable that management responsibilities be redistributed.

With the conventional technique disclosed in Japanese Unexamined Patent Publication No. Hei 10-257048 or No. 2000-76192 for using cookies to disperse management costs for access control, and the conventional technique disclosed in Japanese Unexamined Patent Publication No. 2000-286840 for authenticating clients using public keys to reduce the management costs incurred by servers, the management effort required in servers for client authentication, i.e., the costs for the above authentication management, can be reduced. However, the management costs incurred by the access management for accessing a resource held by the server can not be reduced.

Further, according to the conventional technique disclosed in reference “Cross-Domain One-Shot Authorization Using Smart Cards”, while the management costs for the approval of information access rights is dispersed to clients by using a token that includes the approval rights, the token does not include information directly indicating the information (resources) in the server to be accessed. That is, this technique is provided on the assumption that the application server includes a process by which the approval information incorporated in the token can be compared with the information management data of an application server, and that the data that can be accessed, in accordance with the approval information provided with the token, can be finally determined. Thus, the cost for the access management to resources controlled by the application server will not be reduced, when the application server receives a request to access resources from the client.

It is, therefore, the object of the present invention to provide an access control mechanism in remote procedure calls whereby server management costs for the processing associated with the authentication management of client access rights and with the access management to requested resources can be reduced by distributing these costs among clients.

### SUMMARY OF THE INVENTION

To achieve the above object, according to the present invention, a server having the following configuration is provided. A server for responding to a request from clients via a network, comprising: operating information generation means, in response to a request from a first client which has an access right to the server for execution of a predetermined process, for generating operating information which specifies a remote procedure call permitting a second client to request the server to execute said predetermined process; and data set (token) generation means for generating a data set (token) that includes said operating information generated by said operating information generation means.

The token generation means can include, in the token, client identification information for designating the second client by whom a remote procedure call is permitted. Further, to prevent the alteration of the token, the token generation means can provide a digital signature for the token, or can encrypt the token. The operating information generation means generates the operating information through interaction with the first client who has the right to make a predetermined remote procedure call to the server. That is, the operating information can be generated based on the contents of an operation that the predetermined client has performed for the server, and can be written in the token.

According to the present invention, a server having another configuration can be provided. The server comprises: reception means, for receiving a token that includes operating information corresponding to a remote procedure call a predetermined client is permitted to make; token examination means, for examining if the token is authorized; and process execution means for, if it is ascertained that the token is authorized, performing a process based on the operating information included in the token.

The server further comprises: client authentication means, for authenticating the client by which the token has been transmitted, wherein the token examination means employs the authentication results obtained by the client authentication means to determine whether the client who transmitted the token is the client who is permitted to issue the remote procedure call that corresponds to the operating information included in the token.

The token examination means belonging to the server can employ a digital signature provided for the token to determine whether the token has been altered.

Furthermore, according to the present invention, a server, which executes a process upon receiving a request from a client connected via a network, comprises: data set generation means, for generating a data set that includes operating information corresponding to a remote procedure call that the client is permitted to make; verification means, for examining the authorization for the data set that is transmitted by the client who received the data set; and process execution means, for, when the data set is authorized, performing a process based on the operating information included in the data set.

The data set generation means writes client authentication information in the data set, and the verification means compares authentication information, which is obtained by an authentication process performed when the client transmits the data set in which the authentication information is written. Thus, it can be ascertained that the client who transmitted the data set is the person to whom the data set was issued.

Furthermore, according to the present invention, an information processing apparatus having the following configuration can be provided. An information processing apparatus to be connected to a network comprises: connection means, for establishing a connection with a predetermined server via the network; and remote procedure calling means, for transmitting, to the server for which the information processing apparatus does not have an access right, a token in which authorization for an operation, including permission to access a resource of the server, is written and in this manner permitting the server to perform the operation written in the token.

The connection means provides, for the server, information that is used to confirm that the token has been issued to the information processing apparatus. The information can be a public key used for authentication in accordance with the public key infrastructure (PKI).

According to the present invention, an access control system comprises: a server for performing a data process; and a client to be connected to the server via a network, wherein control is provided for an access request transmitted by the client to the server, wherein the server issues to the client a token that includes identification information for the client and operating information corresponding to a remote procedure call that is permitted for the client, and wherein the client transmits to the server the token issued by the server, so as to perform the remote procedure call that corresponds to the operating information written in the token.

The access control system further comprises: a different client having a right to issue a predetermined remote procedure call to the server, wherein the server employs the remote procedure call issued by the different client to determine operating information to be written in a token.

When the server is a WWW (World Wide Web) server, the token or the data set can be generated by using a cookie. The present invention can also be provided as a program that controls a computer for the implementation of the functions of the above server. This program can be distributed by being stored on a magnetic disk, an optical disk, a semiconductor memory or another storage device, or by being transmitted, via a network, by the storage device of a program transmission apparatus connected to the network.

In addition, an access control method for controlling the access of a second information processing apparatus by a first information processing apparatus, comprises the steps of: determining what operating contents the second information processing apparatus permits the first information processing apparatus; generating a token that includes the operating contents; distributing the token to the first information processing apparatus; and permitting the second information processing apparatus to perform a process based on the token received from the first information processing apparatus.

The access control method further comprises the step of: verifying that the token was generated for the first information processing apparatus, wherein the step of generating the token includes the step of writing, in the token, authentication information for the first information processing apparatus, and wherein the step of verifying that the token was generated for the first information processing apparatus includes the step of comparing authentication information written in the token with authentication information that is obtained during an authentication process performed when the first information processing apparatus transmits the token to the second information processing apparatus.

The access control method further comprises the step of: examining the authorization contained in the token, wherein the step of generating the token includes providing a digital signature for the token, and wherein the step of examining the authorization contained in the token includes the step of examining the digital signature provided for the token received from the first information processing apparatus.

The step of generating the token includes the step of: encrypting the token, and the step of examining the authorization contained in the token includes the step of: examining the decryption results obtained for the token received from the first information processing apparatus.

### BRIEF DESCRIPTION OF THE DRAWINGS

FIG. 1 is a diagram for explaining the general configuration of a network system that implements access control in accordance with one embodiment of the present invention.

FIG. 2 is a diagram showing the configuration of a server according to the embodiment.

FIG. 3 is a diagram showing the format used for a secure token according to the embodiment.

FIG. 4 is a diagram for explaining the access control method according to the embodiment.

FIG. 5 is a diagram for explaining the arrangement wherein this embodiment is employed for an ad hoc radio communication network environment using a handy information process terminal.

FIG. 6 is a diagram showing the relationship between a PDA and a notebook PC for information communication in FIG. 5.

FIG. 7 is a diagram showing the structure of the database of the notebook PC in FIG. 5.

FIG. 8 is a diagram showing a client search condition selection screen used to prepare operating information written in a secure token according to the embodiment.

FIG. 9 is a diagram showing a client display screen on which one entry is selected to prepare the operating information written in a secure token according to the embodiment.

FIG. 10 is a diagram showing a client display screen on which a condition selected in FIG. 9 is set to prepare operating information written in a secure token according to the embodiment.

FIG. 11 is a diagram showing a client display screen on which a second entry is selected to prepare operating information written in a secure token according to the embodiment.

FIG. 12 is a diagram showing a client display screen on which a condition selected in FIG. 11 is specifically designated to prepare operating information written in a secure token according to the embodiment.

FIG. 13 is a diagram showing a client display screen on which a third entry is selected to prepare operating information written in a secure token according to the embodiment.

FIG. 14 is a diagram showing a client display screen on which a condition selected in FIG. 13 is specifically designated to prepare operating information written in a secure token according to the embodiment.

FIG. 15 is a diagram showing a client display screen on which search results based on the input search condition are displayed to prepare operating information written in a secure token according to the embodiment.

FIG. 16 is a diagram showing a client display screen on which a first entry is selected to select another client for whom a secure token according to the embodiment is to be generated.

### DETAILED DESCRIPTION OF A PREFERRED EMBODIMENT OF THE INVENTION

The preferred embodiment will now be described in detail while referring to the accompanying drawings.

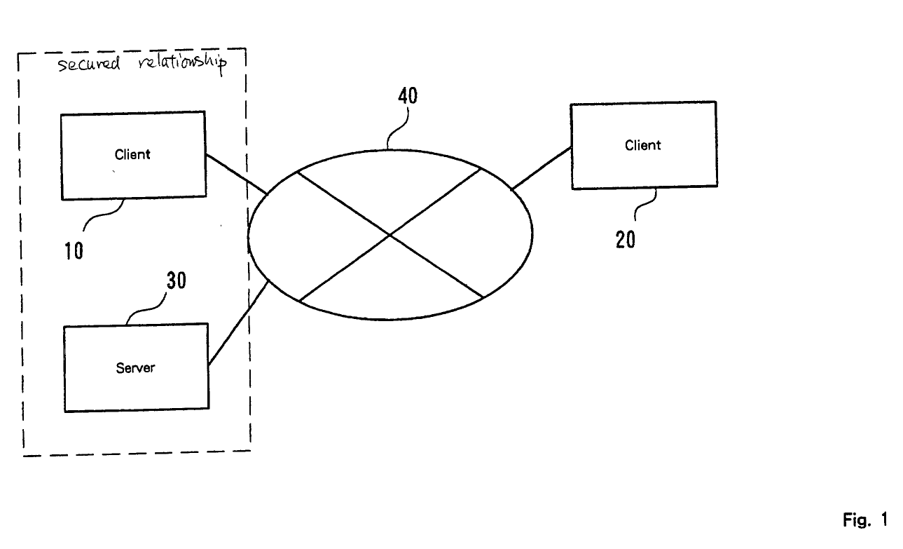

FIG. 1 is a diagram for explaining the general configuration of a network system according to the embodiment whereby access control is exercised. In the network system in FIG. 1 for this embodiment, clients 10 and 20 are connected to a server 30 via a network 40.

The clients 10 and 20, and the server 30 are implemented by a computer, such as a personal computer or a workstation, by a PDA or a mobile phone having a function that enables connection to the network 40, or by another information processing terminal. In this embodiment, apparatuses capable of making remote procedure calls are defined as the clients 10 and 20, and an apparatus that performs operations in response to remote procedure calls is defined as the server 30. In FIG. 1, the client 10 and the server 30 trust each other or have a secured relationship with each other. That is, the client 10 can issue all the available remote procedure calls to the server 30. This condition of reliance is not established between the client 20 and the server 30, and the client 20 has no access rights, or its access rights are limited.

Independent of whether a wired or wireless connection is used, the network 40 can be an arbitrary WAN (Wide Area Network), such as the Internet or an intranet, a LAN (Local Area Network), or an ad hoc radio communication network. In FIG. 1, only two clients 10, 20 and one server 30 are shown; however, no limitation is placed on the number of these components that can be employed.

In this embodiment, the client 10, which is connected to the server 30 via the network 40, can issue a remote procedure call, and can also communicate with the client 20, from which it can obtain identification information. Any inter-client communication method can be employed, so long as peer-to-peer communication is available, such as an easy data exchange method at the application level by the OBEX (Object Exchange) protocol. The client 10 requests the server 30 to issue a token, comprising a data set for permitting the client 20 a limited access to the server 30 (hereinafter referred to as a secure token or a token), and subsequently transfers the secure token prepared by the server 30 to the client 20. As is described above, the client 20 has no access rights relative to the server 30; however, when the client 20 transmits a remote procedure call using the secure token received from the client 10, limited access is granted. A detailed description of a secure token will be provided later.

The server 30 performs various processes upon receiving remote procedure calls from the client 10, and also issues a secure token for the client 20 when it receives a request from the client 10. Since, as will be described later in detail, the secure token includes operating information which designates a remote procedure call that permits the execution of a certain process, and identification information for the client 20 who issues the remote procedure call. If the client 20 designated by the identification information uses the secure token to access the server 30, the server 30 accepts the remote procedure call corresponding to the operating information written in the secure token and initiates the requested process.

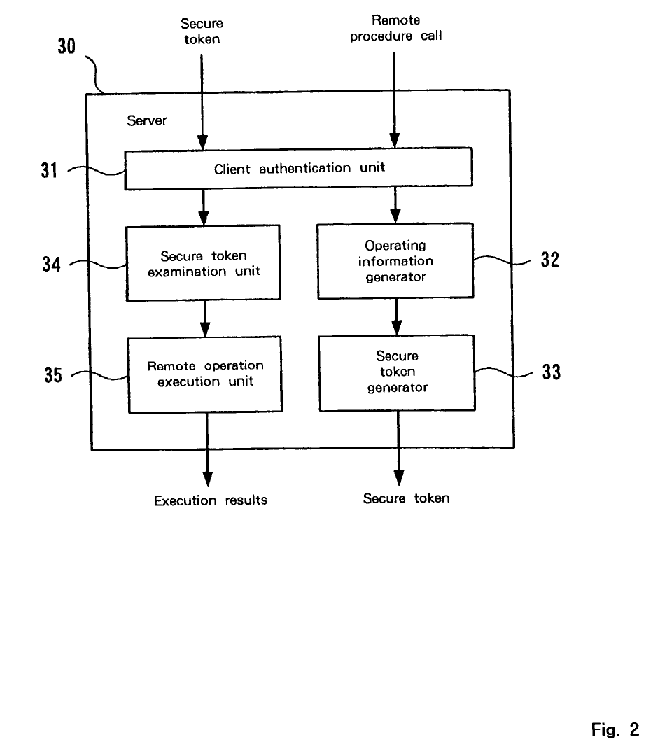

FIG. 2 is a diagram showing the configuration of the server 30. In FIG. 2, the server 30 that exercises an access control operation for this embodiment comprises: a client authentication unit 31, for performing mutual authentication between the clients 10 and 20 that request connection with the server 30; an operating information generator 32, for generating operating information to specify an operation permitted to the client 20 in a remote procedure call; a secure token generator 33, for generating a secure token; a secure token examination unit 34, for examining the secure token received from the client 20; and a remote operation execution unit 35, for performing a process in response to the remote procedure call. These components of the server 30 are virtual software blocks implemented by a CPU controlled by a program executed by a computer system, which functions as the server 30. The program used to control the CPU can be provided by being stored on a storage medium, such as a CD-ROM or a floppy disk, or by being transmitted via a network.

With this arrangement, the client authentication unit 31 authenticates the clients 10 and 20 that request a connection to the server 30. During the authentication process, for example, mutual authentication in accordance with the PKI (Public Key Infrastructure) can be employed. Thus, if mutual authentication in accordance with PKI provisions (e.g., authentication using SSL) is employed and an unauthorized third party who has obtained a secure token attempts to use the token to access a resource available at the server 30, the possibility that the access attempt by the third party will be successful can be completely eliminated at the authentication stage, so long as he or she does not know the secret key (private key) employed by the client 20 for whom the secure token was originally intended. Further, should a malicious client 20 attempt to employ an unauthorized public key and private key (by pretending to be an authenticated user) to request the client 10 to prepare an unauthorized secure token, the possibility that this malicious attempt will succeed can also be eliminated, because a digital certificate, including the public key that is transmitted at the authentication stage while the client 20 is connected to the server 30, is not issued by the appropriate CA (Certification Authority). Therefore, the level of security afforded by the embodiment is equal to the level available with the current PKI.

The operating information generator 32 generates operating information for specifying a limited remote procedure call that allows the client 20 to access the server 30 for the execution of a specific process. The operating information can be generated through interaction with the client 10. That is, a remote procedure call that the client 10 has issued to the server 30 is traced, and the contents (procedures) of this operation are defined as operating information. Specifically, when the client 20 is to be permitted to access specific data in a database provided by the server 30, the client 10 needs only access the pertinent data actually to specify the operating information for this access.

The secure token generator 33 employs the operating information prepared by the operating information generator 32 and the authentication information which is identification information for the client 20, to generate a secure token to be issued to the client 20. The authentication information for the client 20, which will be described in detail later, can be obtained from the client 10. The secure token generator 33 can then perform a predetermined process for the secure token in order to guarantee its correctness (to prevent alteration). For example, the secure token generator 33 can either attach verification data, such as the digital signature of the server 30, to the secure token or it can encrypt the secure token.

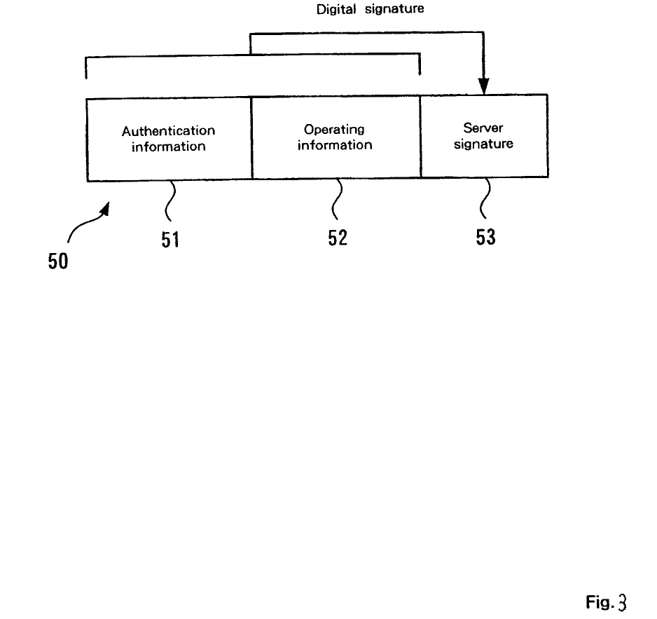

FIG. 3 is a diagram showing an example format for a secure token. In FIG. 3, a secure token 50 includes authentication information 51 for the client 20 and operating information 52 generated by the operating information generator 32. The authentication information 51 for the client 20 can be, for example, a public key used for mutual authentication in accordance with the PKI. Furthermore, a digital signature (a server signature in FIG. 3) 53 is provided for the secure token 50. Not only a direct operation for a resource held or controlled within the server 30 but also an operation for an external resource (e.g., another server connected to the network) that the server 30 can operate can be written in as the operating information 52.

The secure token examination unit 34 examines for correctness of the secure token 50 received from the client 20. In this embodiment, the secure token examination unit 34 verifies the secure token 50 itself and the client 20 that transmitted the secure token 50. The correctness of the secure token 50 is examined by determining whether the secure token 50 has been altered. As is shown in FIG. 3, when a digital signature 53 is provided for the secure token 50, the correctness of the secure token 50 can be confirmed by examining the digital signature 53. If the secure token 50 is encrypted, the secure token 50 is decrypted before it is examined to confirm its correctness.

The client 20 that transmitted the secure token 50 is verified by comparing the authentication information used during the authentication process performed to permit the client 20 to transmit the secure token 50 to the server 30, with the authentication information 51 written in the secure token 50. Therefore, the authentication information for the client 20, which is received from the client 10 for the generation of the secure token 50, and the authentication information obtained by the client authentication unit 31 must have the same form or must have the form that permits their correctness to be mutually confirmed.

The remote operation execution unit 35 executes processes based on remote procedure calls from the client 10, or remote procedure calls from the client 20 which are submitted by using operating information 52 that is written in the secure token 50. Depending on the contents of an operation, the execution results are transmitted by the server 30 to either the client 10 or the client 20. For example, if a data search request for a database managed within the server 30 is issued based on a secure token 50, the search results are transmitted by the server 30 to the client 20. And if the server 30 has the function for accessing an external device and performing a predetermined operation, the external device can also be operated in accordance with the operating information 52 in the secure token 50.

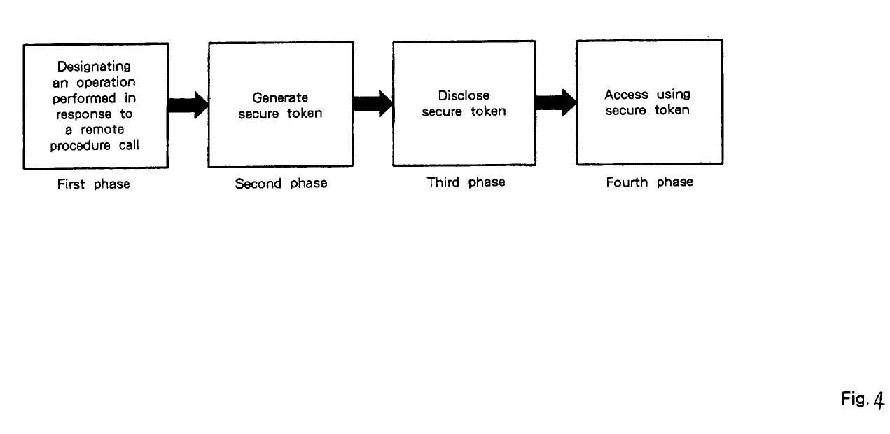

FIG. 4 is a diagram for explaining the access control method according to the embodiment. In FIG. 4, the access control method of this embodiment comprises four phases: a first phase for designating an operation to be executed based on a remote procedure call; a second phase for generating a secure token; a third phase for disclosing the secure token; and a fourth phase for accessing the server 30 using the secure token.

During the first phase, initially, the clients 10 and 20 mutually authenticate each other, and then operating information for a remote procedure call that is to be disclosed to the client 20 is determined. As is described above, it is preferable that the form for mutual authentication between the client 20 and the server 30 be the same as that for mutual authentication between the clients 10 and 20. For example, the mutual authentication process according to the PKI may be employed. Further, the operating information for the remote procedure call can be determined, for example, at the time the client 10 actually performs the pertinent operation.

During the second phase, the server 30, upon receiving a request from the client 10, generates a secure token 50. As is shown in FIG. 3, the secure token 50 includes the authentication information 51 for the client 20 obtained during the first phase and the operating information 52 for the remote procedure call that is disclosed to the client 20. In case, during the first phase, the mutual authentication process used by the clients 10 and 20 is performed according to the PKI, the authentication information 51 can be the public key of the client 20.

During the third phase, the server 30 transmits the secure token 50 to the client 20. The server 30 may either transmit the secure token 50 to the client 20 via the client 10, or it may transmit the secure token 50 directly to the client 20. In either case, only if the secure token 50 is received by the client 20 information concerning the remote procedure call, which is based on the operating information 52 written in the secure token 50, is disclosed to the client 20.

During the fourth phase, the client 20 uses the secure token 50 to access the server 30. Specifically, the client 20 and the server 30 mutually authenticate each other and then the client 20 transmits the secure token 50 to the server 30.

Upon receiving the secure token 50, the server 30 processes the digital signature 53 added to the secure token 50 to determine the correctness of the secure token 50. In this process, whether the secure token 50 has been altered can be determined. Furthermore, the authentication information 51 for the client 20 written in the secure token 50 is compared with authentication information for the client 20 obtained through the previous mutual authentication process. When the two authentication information sets match, it can be ascertained that the secure token 50 has been transmitted by the client 20 to which the secure token 50 was initially issued. Therefore, if the client 20 has transmitted the secure token 50 to a different client, and this client transmits the secure token 50 to the server 30, the authentication information will differ, so that it can be ascertained that the access is not authorized. In other words, the confirmation process performed for the authentication information is used to guarantee that the operating information 52 written in the secure token 50 is disclosed only to the client 20. After this examination, the server 30 executes an operation based on the operating information 52 written in the secure token 50. As is described above, depending on the contents of the operation, the execution results transmitted to the client 20 by the server 30.

As is described above, according to the access control method of this embodiment, the server 30 only executes a remote procedure call based on operating information 52 that has already been approved. That is, if the correctness of the secure token 50 is confirmed, it is not necessary to determine whether the client 20 is permitted to execute a remote procedure call that the client 20 is currently requesting, or to access the requested information. Accordingly, there is no need to maintain specific management data for the client 20 in the server 30 for such determination. In other words, in this embodiment, management of the resource access request issued by the client 20 is based only on the information included in the secure token 50 that the client 20 transmitted.

This access control method is appropriate for a case wherein the client to whom resource information is to be disclosed cannot be designated, and the type of resource information to be provided for the client must be determined after client interaction is initiated.

In case a certain client or group is previously specified, and the resource information to be disclosed to such client or group is recognized in advance (e.g. in case a predetermined client frequently accesses a server), it is more efficient to grant an access to the resources relevant to the role of the pertinent client collectively. However, in a situation wherein it is not known whether the client which once accesses the resources in the server will access them again later, the same management method for the client that frequently accesses the relevant resource is not preferable because management costs are increased. In addition, in this situation, it is rare for the range of the resource information to be disclosed to the client to be widely extended. Rather, the range tends to generally very narrow. This trend is more remarkable when a large, unspecified number of clients accesses the server. Therefore, in this situation, the use of the access control method employed for this embodiment is reasonable.

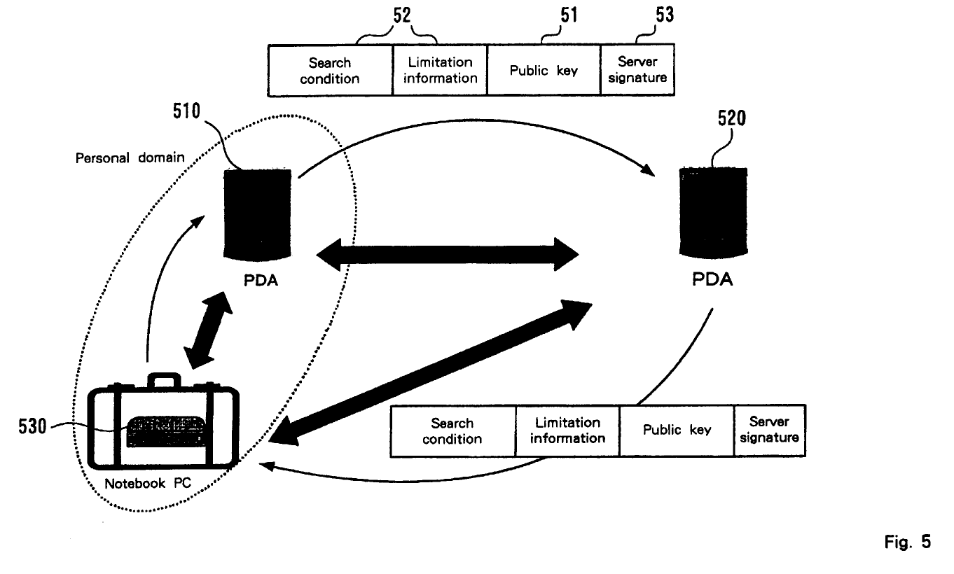

In this embodiment, an example wherein the access control is used to handle a request for a database search will now be specifically explained. FIG. 5 is a diagram for explaining the configuration wherein the method of the embodiment is used for an ad hoc radio communication network environment while employing a mobile information processing terminal.

In the network environment in FIG. 5, PDAs (Personal Digital Assistants) 510 and 520 and a notebook computer 530 (hereinafter referred to as a notebook PC 530) are provided that use the ad hoc radio communication network to exchange information. In FIG. 5, the PDA, 510 corresponds to the client 10 in FIG. 1, the PDA 520 corresponds to the client 20, and the notebook PC 530 corresponds to the server 30. That is, the PDA 510 and the notebook PC 530 are present in the same personal domain and in a secured relationship each other. The PDA 520, however, is not in the secured relationship wit the notebook PC 530, and must employ the secure token 50 of this embodiment to access the database at the notebook PC 530.

In this embodiment, the PDAs 510, 520 and the notebook PC 530 employ a web base system for the exchange of information. Therefore, the notebook PC 530 is a web server, and the PDAs 510 and 520 are equipped with web browsers 511 and 521 that is to be used to connect with the notebook PC 530. Further, from the viewpoint of the operation in this embodiment, the notebook PC 530 is a database server, and the PDAs 510 and 520 issue access requests for the database that the notebook PC 530 can control.

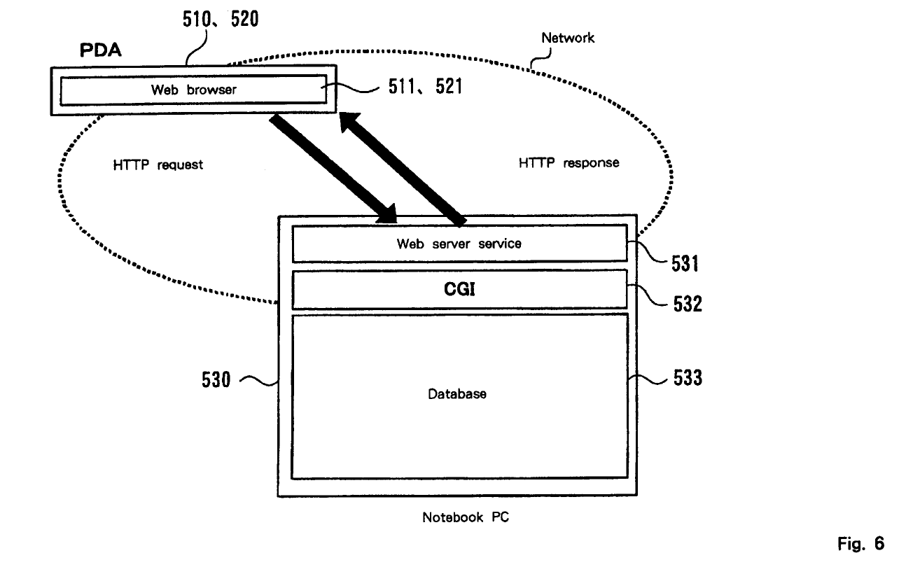

FIG. 6 is a diagram showing the information communication relationship existing between the PDAs 510, 520 and the notebook PC 530. In FIG. 6, the notebook PC 530 includes a web server service unit 531 for providing a service on a web, a CGI (Common Gateway Interface) 532 and a database 533. When the web browsers 511 and 521 provided for the PDAs 510 and 520 transmit HTTP requests to the notebook PC 530, the web server service unit 531 receives these HTTP requests and employs the CGI to search the database 533 for data. The search results is transmitted to the PDAs 510 and 520. Thereafter, the users of the PDAs 510 and 520 use the web browsers 511 and 521 to browse the search results.

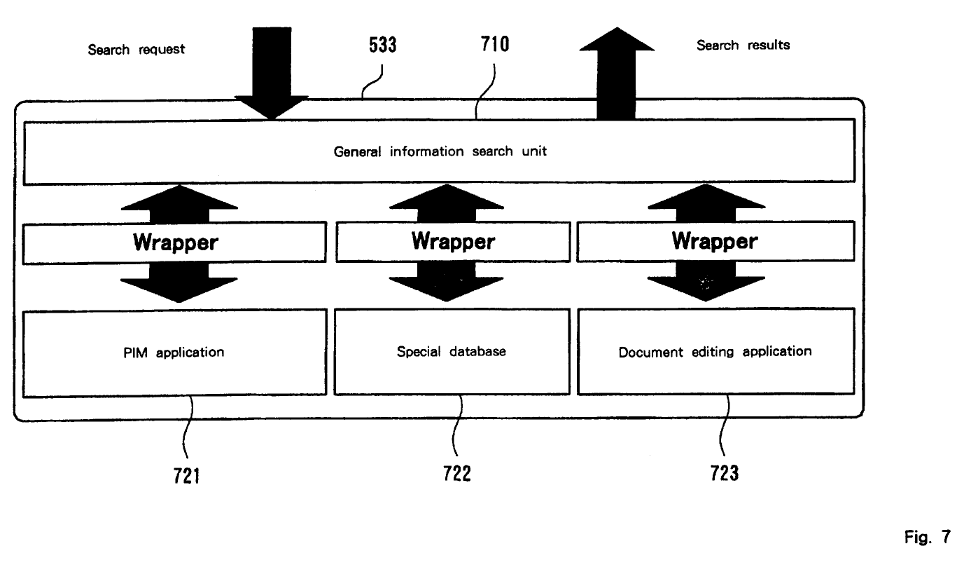

FIG. 7 is a diagram for explaining the configuration of the database 533 at the notebook PC 530. For this embodiment, a database 533 search is performed in accordance with multiple information categories. Therefore, in FIG. 7, the database 533 includes a general information search unit 710 and an application group managed by the general information search unit 710.

The general information search unit 710 provides detailed processing, in accordance with dominated information categories having various access interfaces, for search conditions (queries) in HTTP requests received from the PDA 510 or 520. In this embodiment, the dominated information categories of the general information search unit 710 are personal data (hereinafter referred to as PIM (Personal Information Manager) information), such as e-mail, schedule and address data, data handled in a special database, and document data, including a wide variety of document types, such as PDF (Portable Document format), plain text, and other specific formats. Therefore, in the example in FIG. 7, the application group managed by the general information search unit 710 includes a PIM application 721 for processing PIM information, a special database 722 and a document editing application 723 for processing document data. However, this application group is merely an example, and in some network environments using the access control method of this embodiment, an application for processing image data or audio data can be employed in addition to, or instead of, the above applications.

The special database 722 includes an external database that can be accessed separately through a network and a dedicated database for the intranet. The document editing application 723 includes a word processor and a spreadsheet program.

Further, as is shown in FIG. 7, an access interface conversion layer, called a wrapper, is mounted between the general information search unit 710 and the application group, such as the PIM application 721, the special database 722 and the document editing application 723, so that the general information search unit 710 can uniformly access the different information categories. As a result, differences in entry names to be called or calling procedures can be absorbed. For example, when the PDA 510 instructs the notebook PC 530 to search for information including a specific keyword among the information categories that were accessed in the past two days, the information in each information category that satisfies the condition is searched for and is displayed on the screen of the PDA 510. To simplify the process, all the information may be converted into plain text, or as needed, the document format of the original information may be maintained and displayed by using the function of the PDA 510.

A specific operation will now be described for exercising the access control provided by the PDA 520 in the thus arranged network environment. Assume that one user (user A) holds the PDA 510 and the notebook PC 530, and another user (user B) holds the PDA 520. Since the PDA 510 and the notebook PC 530 trust each other, these two are connected in advance by an encrypted radio communication path. The notebook PC 530, which may be stored in a bag and is in the power saving (suspend) mode, is activated (awakened) and accessed, as needed, upon the reception of a radio signal from the PDA 510.

Assume that the distance between the users A and B is reduced when the two users actually encounter, and the users can communicate with each other through an ad hoc, short-distance radio communication network. Then, using inter-client communication, identification information is first exchanged by the PDAs 510 and 520 to designate communication partners. So even if the PDA 520 of a malicious user pretends to be an arbitrary authorized user and attempts to transmit false identification information to the PDA 510, a system, as previously described, is prepared whereby the PDA 520 of the malicious user is eliminated at the following server connection time in accordance with the PKI.

Following this step, after receiving a request from the user B, the user A employs the PDA 510 to place a remote procedure call to the notebook PC 530, and then accesses the database at the PC 530 and searches for information to be provided for the user B (information that satisfies the request). While taking into account that a call differs depending on a search condition and a category to be searched for, the user A selects desirable information from the items displayed on the display screen of the PDA 510 by changing the search condition. This operation corresponds to the first phase in FIG. 4. In this embodiment, the following required conditions for categories are input, and are collectively transmitted to the notebook PC 530.

creation date

last access date

creator/transmitter

title name/file name

relevant application category type

importance level

unread/read

size

object delivery time

title or file name of information, or a keyword included therein

location of information (a page, a paragraph or a line)

In the PDA 510, when the web browser 511 is operated, and the above necessary entries are input to condition input forms received from the web server of the notebook PC 530, the contents are transmitted to the notebook PC 530 using an HTTP POST command. The information that is input corresponds to the operating information for a remote procedure call issued to the notebook PC 530, i.e., to the web server. In FIG. 6, this information is processed to perform the search of the database 533 via the CGI 532. The method of searching the database 533 is not limited to a technique performed using the web server CGI 532; it may be implemented by adopting a general RPC technique through HTTP, for example, using a SOAP (Simple Object Access Protocol) framework, wherein a specific RPC entry at the server may be called by using a specific call. The above described search is repeated between the PDA 510 and the notebook PC 530 until appropriate information to be provided for the user B is chosen.

When the data search is continued and it is established what information is to be provided for the user B, the operation is shifted to the second phase in FIG. 4. In this phase, the notebook PC 530 is requested to generate a secure token 50, so that the secure token includes the search condition that was used by the PDA 510 to establish what information is to be provided for the user B. That is, the generation of a secure token 50 is requested at this time so that search conditions will be included in the secure token 50 to enable the extraction of the information obtained through the data search corresponding to the remote procedure call issued to the notebook PC 530 by the PDA 510. The purpose of the secure token 50 is to provide the PDA 520, which has no secured relationship with the notebook PC 530, with the same information as that which can be obtained by the PDA 510, which has a secured relationship with the notebook PC 530, by using the search condition therein.

For the secure token 50 of this embodiment, in FIG. 5, the public key of the user B is written in the secure token 50 shown in FIG. 3 as authentication information 51, and the search condition and limitation information (e.g., the valid period of the secure token) are written as operating information 52. Furthermore, a digital signature 53 (a server signature in FIG. 5) is attached to the secure token 50. As is described above, since the notebook PC 530 provides the digital signature 53 for the secure token 50, only the notebook PC 530, which holds the secret key, can generate the secure token 50. In this embodiment, if the PDA 520 and the notebook PC 530 use web base communication with each other, a secure token 50 can be generated for the PDA 520 as a cookie data.

The phase is now shifted to the third phase in FIG. 4. The generated secure token 50 is transmitted to the PDA 520 as a certificate of access for the notebook PC 530. The secure token 50 is temporarily transmitted to the PDA 510, and is then transferred, via inter-client communication, from the PDA 510 to the PDA 520. The secure token 50 may also be transmitted directly to the PDA 520 by the notebook PC 530.

The phase is then shifted to the fourth phase in FIG. 4, and the PDA 520 uses the secure token 50 to perform a data search. When the secure token 50 generated at the second phase is transmitted to the PDA 520 during the third phase, so long as the PDA 520 employs the secure token 50, the PDA 520 is permitted to perform a data search under the search condition written in the secure token 50. This is because, if the PDA 520 is confirmed as it is by the authentication process using the SSL while the PDA 520 is connected to the notebook PC 530, and if the public key that is disclosed in that process matches the public key that is inserted in advance into the secure token, it is confirmed that the secure token 50 is the correct one that was provided for the PDA 520.

An explanation will now be given for an example search condition written as operating information 52. Assume that the following constitutes the search information.

<QueryConditions>

<keywords>

“Web server” AND “CGI”

</keywords>

<LastAccessDateTime>

BETWEEN Jan. 6, 2001 AND Feb. 6, 2001

</LastAccessDateTime>

<SpecifiedCategories>

MAIL AND PDF

</SpecifiedCategories>

</QueryConditions>

In this example, a mail or a PDF document, that was accessed between June 1st and 2nd, and that includes the two keywords “Web server” and “CGI”, is searched for, and the pertinent information is obtained. Therefore, the PDA 520 that has obtained the secure token 50 in which the above search condition is written as operating information 52 can perform a data search of the notebook PC 530 under the search condition. Instead of a plain text document, SOAP coding may be employed for a general PRC to describe the operating information 52 that enables style designation for the transmission information.

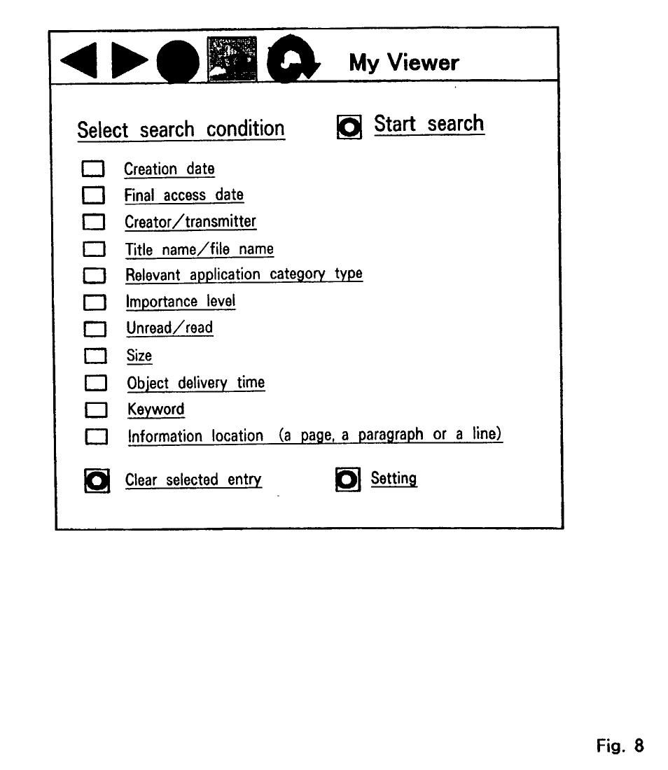

An example wherein the embodiment is applied for a database search will now be explained while referring to FIGS. 8 to 16, wherein a simplified GUI is displayed in the web browser 511 of the PDA 510. In this example, the user A determines the search condition by operating the PDA 510 and provides the operation contents as a secure token 50 for the PDA 520 (user B).

This example is implemented in the ad hoc radio communication network. First, the PDA 510 searches for a nearby device which has the access function using the secure token 50 of this embodiment. That is, a computer system is searched for to which at least a part of the information in the notebook PC 530 is disclosed. For example, when a special service discovery function, prepared in common, is employed between the short-distance radio communication devices that are used by the PDAs 510 and 520, another short-distance radio communication device that is currently being used and is located within communication range (e.g., within an inter-device distance of 10 m) can be searched for. In the following example, assume that the device names of the clients found by the service discovery function are“Paul” and “Robert”. In this example, “Paul” corresponds to the PDA 520. The following operation is initiated on the assumption that the PDA 510 already understands the name of the peripheral device.

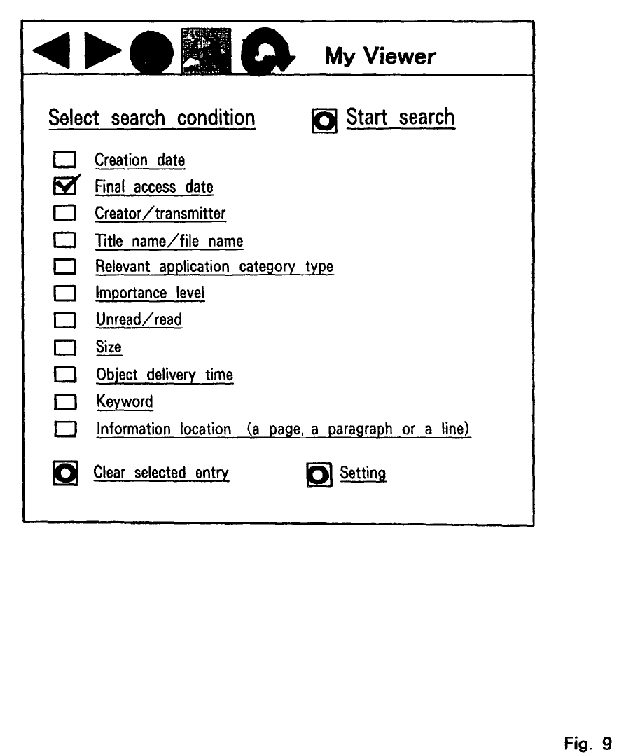

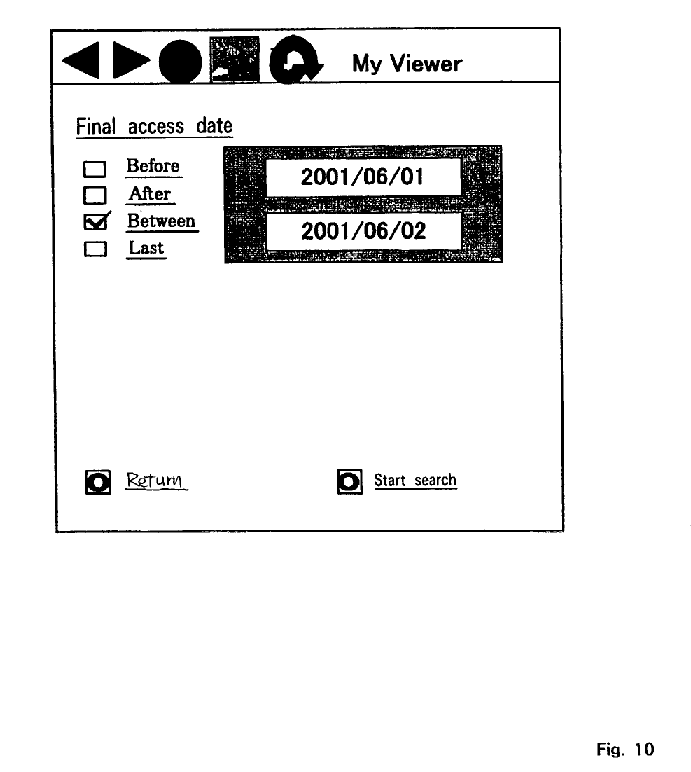

FIG. 8 is a diagram showing an initial screen (homepage) that is provided by the web server of the notebook PC 530 at the beginning of a database search and that is displayed on the web browser 511 of the PDA 510. On this screen, search categories are enumerated for the search engine (database 533) of the notebook PC 530. Assume that the user A selected “final access date” (see FIG. 9). Upon receiving this entry, a special page for setting the final access date in detail is transmitted by the web server of the notebook PC 530 to the PDA 510 (see FIG. 10). In FIG. 10, the user A designates, as a condition, the period from Jun. 1st, 2001 to Jun. 2nd, 2001.

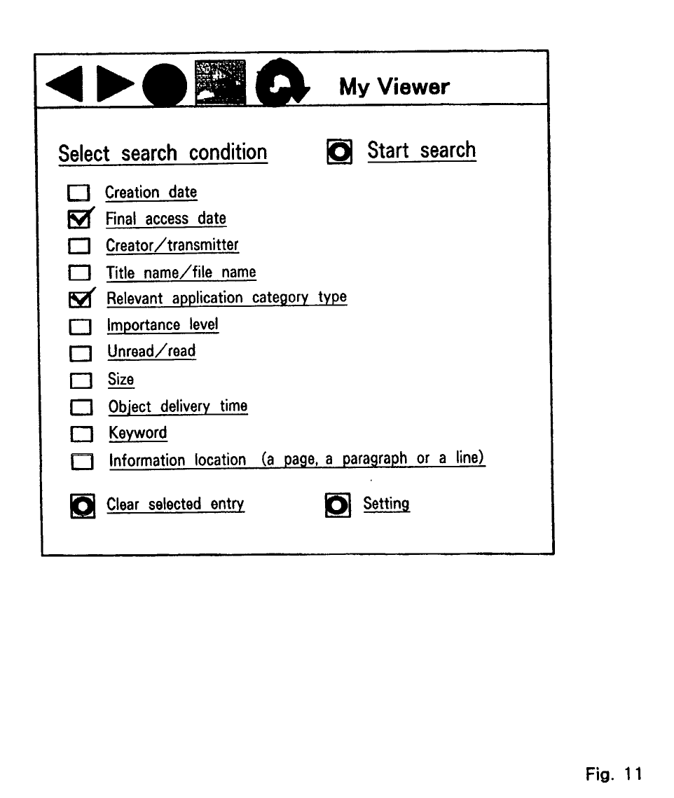

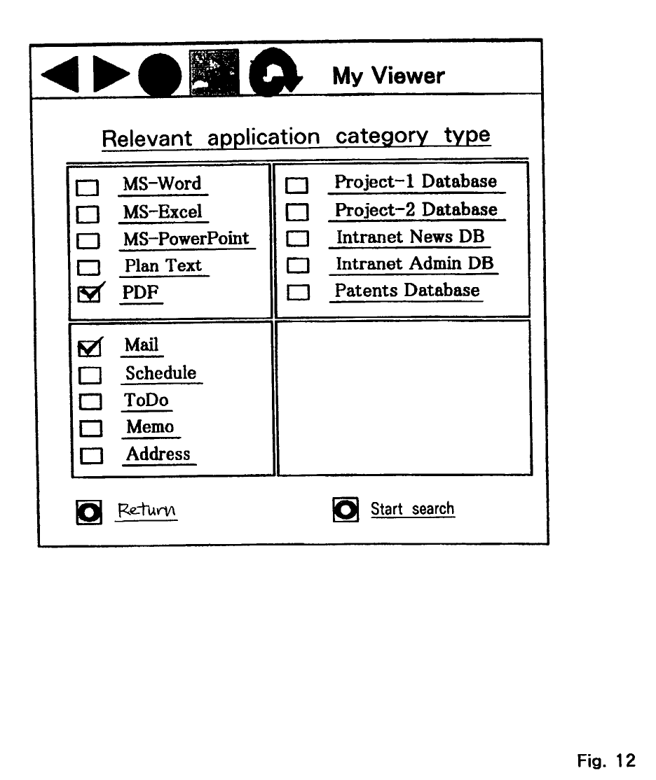

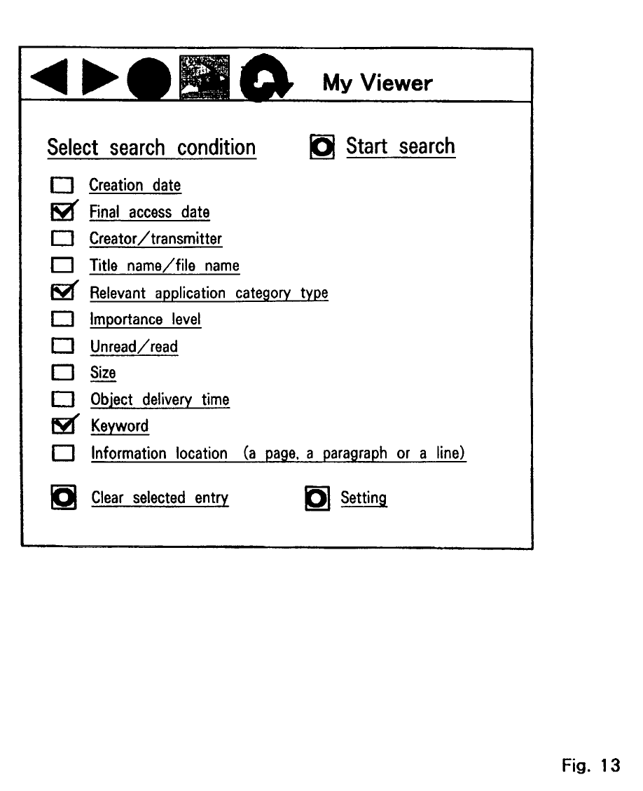

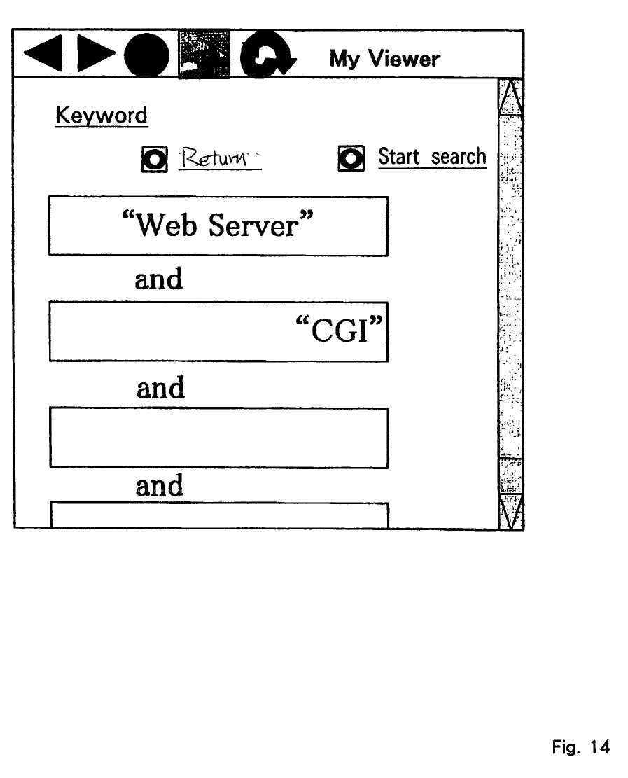

Further, to add the search condition, the user executes “Return” on the screen in FIG. 10, instead of executing “start search”. As a result, the display on the web browser 511 of the PDA 510 is returned to the state in FIG. 9, i.e., the state wherein search condition “final access date” is selected on the homepage. The user A then designates “relevant application category type” (see FIG. 11). Upon receiving this designation, a special page for designating the relevant application category type is transmitted by the web server of the notebook PC 530 to the PDA 510 (see FIG. 12). In the example in FIG. 12, the user A designates a PDF file and mail information as categories. In order to add a further search condition, the user A returns to the homepage as described above and adds the search condition “keyword” (see FIG. 13). Then, the user A enters the two keywords “Web server” and “CGI” on the keyword input page (see FIG. 14).

In the above manner, the contents of the database search are set to perform a search for the PDF information and the mail information that include these keywords. Following this, the user A selects “start search” on the web page in FIG. 14, and requests that the web server of the notebook PC 530 initiate a search operation under the set search conditions.

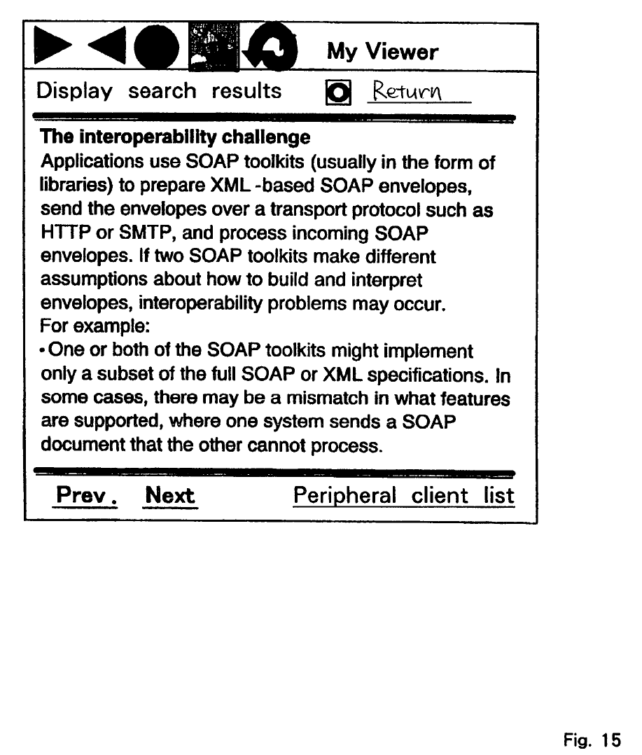

The notebook PC 530 then performs a database search in accordance with the search request. And when it finds a data file that satisfies the search conditions, it transmits the data file to the PDA 510 (see FIG. 15). In the lower portion of the page shown in FIG. 15, a control button is provided for performing a page unit examination of the search results. If the thus obtained search results are the contents desired by the user A (to be disclosed to the user B), the user A requests that the notebook PC 530 generate a secure token 50 that includes this search condition.

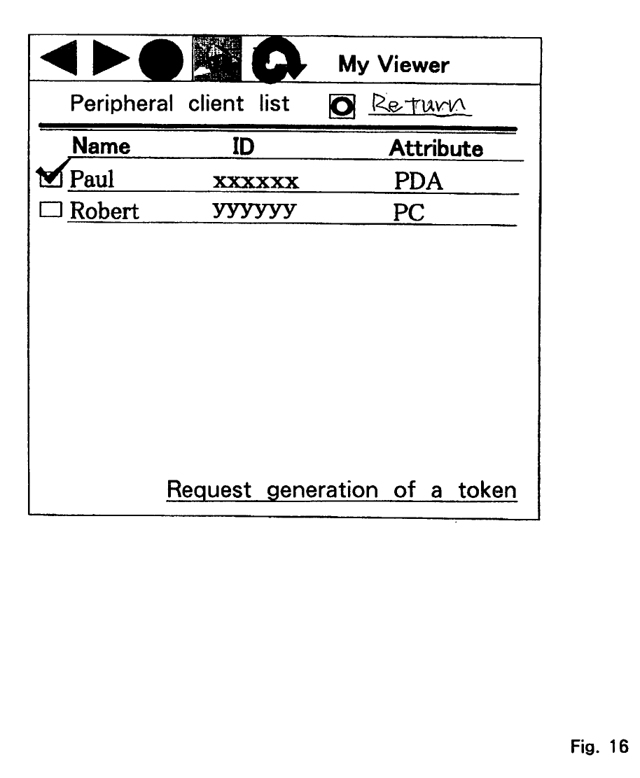

As is described above, the PDA 510 has already searched for the name of a peripheral device. When the search condition is established, the device name and the identification information obtained in the search process are transmitted to the notebook PC 530. It should be noted that since the transmission process is performed using SOAP, which is exchanged in accordance with HTTP, this is not displayed on the PDA 510. Instead, the device name and the identification information are displayed as a list using a peripheral client list button positioned below the search results displayed in FIG. 15 (see FIG. 16).

The user A determines which device (client) will be used to generate a secure token 50. In FIG. 16, for the user (corresponding to the PDA 520) having the device name “Paul”, the notebook PC 530 is requested to generate a secure token 50 for which the above described search conditions are provided. Upon receiving the request, the notebook PC 530 uses the same SOAP to generate the secure token 50, which it transmits to the PDA 510. The PDA 510 transmits the secure token 50 to the PDA 520, via inter-client communication, and discloses specified information for the notebook PC 530. Thereafter, client Paul can obtain the search results in FIG. 15 by transmitting the secure token 50 to the notebook PC 530.

In the above described example, the PDA 510 and the notebook PC 530 are separate devices; however, instead of two devices, a single terminal may be used to provide the same functions. In addition, although not specifically shown in the example, when the notebook PC 530 can access an external database, the right to perform this operation may be provided using a secure token 50.

As is described above, according to this embodiment, when a token in which a server resource access operation to be provided for a client is written is issued to the client, limited access rights for a specific server resource can be provided for the client. Furthermore, when the secure token 50 is transmitted to the client, access control management information can be distributed and managed for each client. Therefore, after management information concerning access control has been disclosed, this information need not be maintained by the server, and the load imposed on the server can be reduced considerably.

The secure token 50 and the conventional access control method that are used separately for the access control method of this embodiment can also be employed together. For example, for a client who frequently accesses a server, access control can be provided by retaining management data in the server, and for a client who accesses the server for the first time, or a client who seldom accesses the server, the access control method of this embodiment can be employed.

As is described above, according to the present invention, for the access control processing performed to service remote procedure calls, management costs for the authentication of access rights for clients and for the accessing of resources can be distributed among clients, and the management costs that must be borne by a server can be reduced.

What is claimed is:

1. A server for responding to a request from clients via a network, comprising:
operating information generation means, in response to a request from a first client which has an access right to the server for execution of a predetermined process, for generating operating information which specifies a remote procedure call permitting a second client to request the server to execute said predetermined process; and
data set generation means for generating a data set that includes the operating information generated by said operating information generation means.

2. The server according to claim 1, wherein said data set generation means includes, in the data set, client identification information for designating the second client.

3. The server according to claim 1, wherein said data set generation means provides a digital signature for the data set.

4. The server according to claim 1, wherein said data set generation means encrypts the data set.

5. The server according to claim 1, wherein said operating information generation means generates said operating information through interaction with the first client.

6. The server according to claim 1, further comprising:
reception means for receiving the data set that includes the operating information from the second client;
examination means for examining if the received data set is authorized; and
execution means, if it is ascertained that the data set is authorized, for executing the predetermined process based on the operating information included in the data set.

7. The server according to claim 6, wherein:
said data set generation means includes client identification information for designating the second client in the data set; and
said examination means compares authentication information, which is obtained by an authentication process performed in response to reception of said data set from the second client, with said client identification information included in the data set.

8. The server according to claim 6, wherein said examination means employs a digital signature for determining whether the data set has been altered.

9. The server according to claim 1, wherein, the server is a WWW (World Wide Web) server, and said data set generation means generates the data set by cookie data.

10. An apparatus to be connected to a network comprising:
connection means for establishing a connection with a predetermined server via said network;
reception means for receiving a data set which includes operating information permitting the apparatus to access a resource in said server, to which the apparatus does not have an access right; and
remote procedure calling means for requesting said server to access the resource by transmitting the received data set.

11. The apparatus according to claim 9, wherein said connection means provides, for said server, information that is used to confirm that said data set has been issued to said apparatus.

12. The apparatus according to claim 10, wherein, as the information that is used to confirm that said data set has been issued to said apparatus, said connection means provides, for said server, a public key for authentication in accordance with the public key infrastructure (PKI).

13. A method for controlling an access by a first apparatus to a second apparatus, comprising the steps of:
determining an operation that the second apparatus permits the first apparatus to request to perform, in response to a request from a third apparatus which has an access right to the second apparatus;
generating a data set that specifies said operation at the second apparatus;
transmitting the data set to the first apparatus; and
performing said operation at the second apparatus in response to said transmitting step.

14. The method according to claim 13, further comprising the step of verifying that the data set is generated for the first apparatus, wherein :
said step of generating the data set comprises the step of including, in the data set, first authentication information for the first apparatus, and
said step of verifying comprises the step of comparing the first authentication information included in the data set with second authentication information that is obtained during an authentication process performed when the first apparatus transmits the data set to the second apparatus.

15. The method according to claim 13, further comprising the step of examining correctness of the data set, wherein :
said step of generating the data set comprises the step of providing a digital signature for the data set, and
said step of examining the correctness comprises the step of examining said digital signature provided for the data set received from the first apparatus.

16. The method according to claim 13, further comprising the step of examining correctness of the data set, wherein:
said step of generating the data set comprises the step of encrypting the data set, and
said step of examining the correctness comprises the step of examining the decryption results obtained for the data set received from the first apparatus.
